(19) United States
(12) Patent Application Publication
(10) Pub. No.: US 2015/0213770 A1
(43) Pub. Date: Jul. 30, 2015

(54) DISPLAY DRIVING DEVICE AND METHOD

(71) Applicant: SAMSUNG ELECTRONICS CO., LTD., Suwon-si (KR)

(72) Inventor: SEUNG-HOON BAEK, Seongnam-si (KR)

(73) Assignee: SAMSUNG ELECTRONICS CO., LTD., Suwon-si (KR)

(21) Appl. No.: 14/529,273

(22) Filed: Oct. 31, 2014

(30) Foreign Application Priority Data
Jan. 27, 2014 (KR) 10-2014-0009835

(51) Int. Cl. G09G 3/36

(52) U.S. Cl. CPC G09G 3/3607; G09G 3/3659; G09G 2310/027; G09G 2310/0272; G09G 2310/0286; G09G 2310/0289; G09G 2310/0297; G09G 2310/08

(57) ABSTRACT

Display driving device and method are provided. The display driving device includes a timing controller configured to compare previous pixel data and current pixel data in units of a line, add or subtract n-bit weight data to or from the current pixel data based on the compared result, and generate the added or subtracted current pixel data as overdriving pixel data, and a channel driver configured to transmit a gray scale voltage corresponding to the overdriving pixel data to a display panel, during an overdriving operation.

### CROSS-REFERENCE TO RELATED APPLICATIONS

This application claims priority under 35 U.S.C. §119 to Korean Patent Application No. 10-2014-0009835 filed on Jan. 27, 2014, the entire contents of which are incorporated herein by reference in their entirety.

### BACKGROUND OF THE INVENTION

1. Field of the Invention

Embodiments of the present inventive concept relate to a display driving device, and more particularly, to a display driving device and method which perform an overdriving operation based on data.

2. Description of the Related Art

A display device includes a display panel in which a plurality of unit pixels for displaying an image are arranged, a gate driver for driving gate lines of the display panel, and a source driver for providing display data for data lines of the display panel so as to display the image. When the display data of a predetermined number of bits is provided, the source driver provides an output signal with a predetermined target value for driving the unit pixel for the display panel, and displays the image on the display panel within one horizontal period (1H).

As size and resolution of the display panel are increased, the target voltage of the output signal provided from the source driver to the display panel is increased. That is, as the size and resolution of the display panel are increased, load resistance and capacitance of a load capacitor connected to an output terminal of the source driver are increased, and the target voltage of the output signal is increased.

Therefore, due to the increase of the capacitance and resistance of an output load according to the increase of the size and resolution of the display panel, an RC delay of the output load becomes greater than a slew rate of an output terminal of the source driver. Accordingly, even when the output signal with a predetermined target voltage provided from the output terminal is supplied to the unit pixels of the display panel, a load of each of the unit pixels cannot reach a level of the predetermined target voltage within a predetermined time. That is, when the resistance and the capacitance of the output load of the source driver used in the display device which has a large panel size and a high resolution are large and 1 horizontal period (1H) is relatively short, the unit pixels cannot reach the level of the predetermined target voltage within the predetermined time since the RC delay of the load is too large no matter how fast the slew rate of the output terminal may be. Accordingly, it is not possible to display a desired image on the display panel properly.

### SUMMARY OF THE INVENTION

Embodiments of the present inventive concept provide a display driving device which compares previous pixel data and current pixel data in units of a line, adds or subtracts n-bit weight data to or from the current pixel data based on the compared result, and performs an overdriving operation based on the added or subtracted current pixel data.

Embodiments of the present inventive concept also provide a display driving method for the display driving device.

Additional features and utilities of the present general inventive concept will be set forth in part in the description which follows and, in part, will be obvious from the description, or may be learned by practice of the general inventive concept.

Exemplary embodiments of the present inventive concept provide a display driving device which includes: a timing controller configured to compare previous pixel data and current pixel data in units of line, add or subtract n-bit weight data to or from the current pixel data based on the compared result, and generate the added or subtracted current pixel data as overdriving pixel data; and a channel driver configured to transmit a gray scale voltage corresponding to the overdriving pixel data to a display panel, during an overdriving operation.

In an exemplary embodiment, the timing controller may add the n-bit weight data to the current pixel data, when the current pixel data is greater than the previous pixel data.

In an exemplary embodiment, the timing controller may subtract the n-bit weight data from the current pixel data, when the current pixel data is smaller than the previous pixel data.

In an exemplary embodiment, the timing controller may maintain the current pixel data, when the current pixel data is equal to the previous pixel data.

In an exemplary embodiment, the display driving device may further include: a shift register configured to store each of the current pixel data and the overdriving pixel data; a MUX controller configured to output one of the current pixel data and the overdriving pixel data; and a level shifter configured to shift a voltage level of the current pixel data or the overdriving pixel data received from the MUX controller.

In an exemplary embodiment, the display driving device may further include a decoder configured to decode the current pixel data or the overdriving pixel data received from the level shifter.

In an exemplary embodiment, the display driving device may further include a gray scale generator configured to transmit the gray scale voltage to the decoder.

In an exemplary embodiment, the timing controller may generate a MUX control signal for controlling the overdriving operation, and the MUX controller may output one of the current pixel data and the overdriving pixel data in response to the MUX control signal.

In an exemplary embodiment, the current pixel data may include 8-bit data, and the n may be greater than or equal to 3 and be smaller than or equal to 5.

In an exemplary embodiment, the channel driver may transmit the gray scale voltage corresponding to the current pixel data to the display panel, during a normal operation.

Exemplary embodiments of the present inventive concept also provide a display driving method which includes: comparing current pixel data and previous pixel data in units of line; adding or subtracting n-bit weight data to or from the current pixel data based on the compared result; generating the added or subtracted current pixel data as overdriving pixel data; and transmitting a gray scale voltage corresponding to the overdriving pixel data to a display panel, during an overdriving operation.

In an exemplary embodiment, the adding or subtracting of the n-bit weight data to or from the current pixel data based on the compared result, may include: adding the n-bit weight data to the current pixel data, when the current pixel data is greater than the previous pixel data; and subtracting the n-bit weight data from the current pixel data, when the current pixel data is smaller than the previous pixel data.

In an exemplary embodiment, the adding or subtracting of the n-bit weight data to or from the current pixel data based on the compared result, may include maintaining the current pixel data, when the current pixel data is equal to the previous pixel data.

In an exemplary embodiment, the display driving method may further include: storing each of the current pixel data and the overdriving pixel data; and outputting one of the current pixel data and the overdriving pixel data in response to a MUX control signal for selecting the overdriving operation.

In an exemplary embodiment, the display driving method may further include shifting a voltage level of the current pixel data or the overdriving pixel data.

Exemplary embodiments of the present inventive concept also provide a display driving device, comprising: a timing controller configured to compare previous pixel data and current pixel data in units of a line and to generate overdriving pixel data based on the comparison; and a channel driver configured to transmit a gray scale voltage corresponding to the overdriving pixel data to a display panel, during an overdriving operation, otherwise to transmit a gray scale voltage corresponding to the current pixel data to a display panel during a normal operation.

In an exemplary embodiment, the timing controller generates the overdriving pixel data by adding or subtracting n-bit weight data to or from the current pixel data based on the compared result to provide the overdriving pixel data.

In an exemplary embodiment, the timing controller adds the n-bit weight data to the current pixel data, when the current pixel data is greater than the previous pixel data, subtracts the n-bit weight data from the current pixel data, when the current pixel data is smaller than the previous pixel data, and maintains the current pixel data, when the current pixel data is equal to the previous pixel data.

In an exemplary embodiment, the display driving device further comprises: a shift register configured to store each of the current pixel data and the overdriving pixel data; a MUX controller configured to output one of the current pixel data and the overdriving pixel data; and a level shifter configured to shift a voltage level of the current pixel data or the overdriving pixel data received from the MUX controller.

In an exemplary embodiment, the display driving device further comprises: a shift register configured to store each of the current pixel data and the overdriving pixel data; a MUX controller configured to output one of the current pixel data and the overdriving pixel data; and a level shifter configured to shift a voltage level of the current pixel data or the overdriving pixel data received from the MUX controller.

### BRIEF DESCRIPTION OF THE DRAWINGS

The foregoing and other features and utilities of the present inventive concepts will be apparent from the more particular description of preferred embodiments of the inventive concepts as provided below, and as illustrated in the accompanying drawings in which like reference characters refer to the same parts throughout the different views. The drawings are not necessarily to scale, emphasis instead being placed upon illustrating the principles of the inventive concepts. In the drawings:

FIG. 1 is a block diagram illustrating a display device according to an embodiment of the inventive concept;

FIG. 2 is a circuit diagram illustrating a channel driver and a display panel shown in FIG. 1;

FIGS. 3A and 3B illustrate an input signal of the channel driver shown in FIG. 2, respectively; FIG. 4 is a graph showing a variation of voltage according to a time in the display panel shown in FIG. 2;

FIGS. 5A and 5B are a graph showing a load voltage according to a time at a node A shown in FIG. 2, respectively; FIG. 6 is a block diagram illustrating a timing controller shown in FIG. 1;

FIG. 7 is a block diagram illustrating a shift register, an MUX controller, and a level shifter shown in FIG. 1; FIG. 8 is a circuit diagram illustrating a decoder and a gray scale generator shown in FIG. 1;

FIG. 9 is a timing diagram for describing an operation of a display driving circuit shown in FIG. 1;

FIG. 10 is a flowchart for describing an operation method of a display driving circuit shown in FIG. 1;

FIG. 11 is a block diagram illustrating one embodiment of a computer system including the display device shown in FIG. 1; FIG. 12 is a block diagram illustrating another embodiment of a computer system including the display device shown in FIG. 1; and

FIG. 13 is a block diagram illustrating still another embodiment of a computer system including the display device shown in FIG. 1.

### DETAILED DESCRIPTION OF THE PREFERRED EMBODIMENTS

Example embodiments of the present inventive concept are described below in sufficient detail to enable those of ordinary skill in the art to embody and practice the present inventive concept. It is important to understand that the present inventive concept may be embodied in many alternate forms and should not be construed as limited to the example embodiments set forth herein.

It will be understood that, although the terms first, second, A, B, etc. may be used herein in reference to elements of the inventive concept, such elements should not be construed as limited by these terms. For example, a first element could be termed a second element, and a second element could be termed a first element, without departing from the scope of the present inventive concept. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the present inventive concept is not intended to limit the scope of the present inventive concept. The articles “a,” “an,” and “the” are singular in that they have a single referent; however the use of the singular form in the present document should not preclude the presence of more than one referent. In other words, elements of the present inventive concept referred to in singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Meanwhile, when it is possible to implement any embodiment in any other way, a function or an operation specified in a specific block may be performed differently from a flow specified in a flowchart. For example, consecutive two blocks may actually perform the function or the operation simultaneously, and the two blocks may perform the function or the operation conversely according to a related operation or function.

Embodiments of the present inventive concept will be described below with reference to attached drawings.

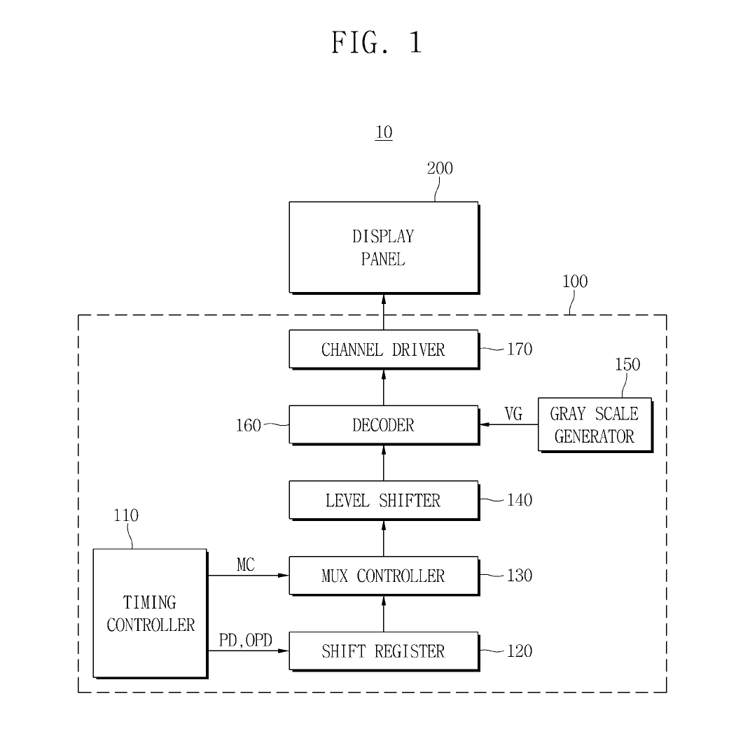

FIG. 1 is a block diagram illustrating a display device according to an embodiment of the present inventive concept.

Referring to FIG. 1, a display device 10 according to an embodiment of the present inventive concept includes a display driving device 100, and a display panel 200.

The display driving device 100 includes a timing controller 110, a shift register 120, a multiplexer (MUX) controller 130, a level shifter 140, a gray scale generator 150, a decoder 160, and a channel driver 170. In an exemplary embodiment, the shift register 120, the MUX controller 130, the level shifter 140, the gray scale generator 150, the decoder 160, and the channel driver 170 may be implemented as a source driver.

The timing controller 110 generates overdriving pixel data OPD to perform an overdriving operation. The overdriving pixel data OPD is generated by adding or subtracting n-bit weight data to or from pixel data PD. In an exemplary embodiment, when the pixel data has 8-bit color depth, n may be set to have a value greater than or equal to 3, and smaller than or equal to 5.

The timing controller 110 transmits the pixel data PD and the overdriving pixel data OPD to the shift register 120. Further, the timing controller 110 transmits a MUX control signal MC to activate the overdriving operation to the MUX controller 130. The timing controller 110 will be described in detail with reference to FIG. 6.

The shift register 120 shifts the pixel data PD or the overdriving pixel data OPD in series, and transmits the shifted pixel data PD and the overdriving pixel data OPD to the MUX controller 130 in parallel.

The MUX controller 130 transmits one of the pixel data PD and the overdriving pixel data OPD to the level shifter 140 in response to the MUX control signal MC. The level shifter 140 shifts a voltage level of the pixel data PD or the overdriving pixel data OPD.

The gray scale generator 150 generates a gray scale voltage VG corresponding to decoded pixel data. The gray scale generator 150 transmits the gray scale voltage VG to the decoder 160. For example, when the pixel data PD is 8-bit data, the gray scale generator 150 generates 2⁸ gray scale voltages VG. Further, the gray scale generator 150 may extend the number of gray scale voltages so as to correspond to the overdriving pixel data OPD. The gray scale generator 150 according to an embodiment of the present inventive concept will be described with reference to FIG. 8.

The decoder 160 converts the pixel data PD or the overdriving pixel data OPD into an analog signal based on the gray scale voltage VG. That is, the decoder 160 receives the gray scale voltage VG from the gray scale generator 150, and transmits the gray scale voltage VG corresponding to the pixel data PD or the overdriving pixel data OPD to the channel driver 170.

The channel driver 170 transmits the converted analog signal to the display panel 200 for driving the display panel 200. In an exemplary embodiment, the channel driver 170 may be implemented by a non-inverting operational amplifier (OP AMP).

The display panel 200 may include a liquid crystal display panel, but it is not limited thereto. In an exemplary embodiment, when the display device 10 is applied to a mobile device such as smart phones, the display panel 200 may be implemented to have a gate driver.

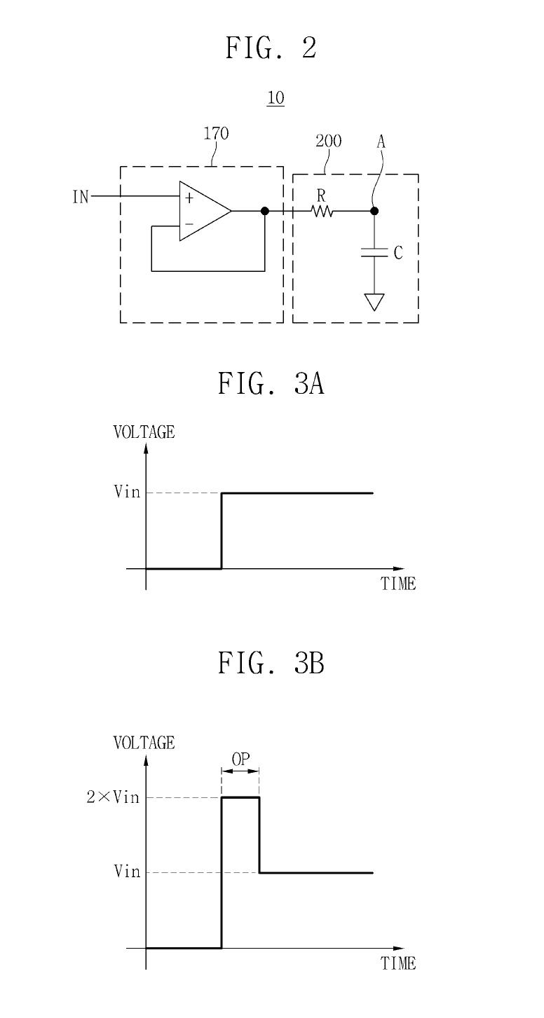

The display driving device 100 according to an embodiment of the present inventive concept compares previous pixel data and current pixel data in units of a line, and adds or subtracts the n-bit weight data to or from the current pixel data based on the compared result. Further, the display driving device 100 provides a gray scale voltage VG corresponding to the added or subtracted current pixel data for the display panel 200. Therefore, the display driving device 100 can perform the overdriving operation. The overdriving operation will be described with reference to FIGS. 2 to 5B.

FIG. 2 is a circuit diagram illustrating a channel driver and a display panel shown in FIG. 1.

Referring to FIGS. 1 and 2, the channel driver 170 may be implemented by a non-inverting operational amplifier (OP AMP). The channel driver 170 receives an input signal IN from the decoder 160. An output of the channel driver 170 is connected to the display panel 200.

The display panel 200 includes a plurality of scan lines (not shown), a plurality of data lines (not shown), and a plurality of unit pixels connected to the plurality of scan lines and the plurality of data lines.

For brevity, the display panel 200 may be represented as one unit pixel. The one unit pixel may be represented as one resistor R and one capacitor C which are serially connected. A node A is between the resistor R and the capacitor C. A load of the display panel 200 may be measured at the node A. A target voltage level to operate the display panel 200 is set as Vload. A voltage applied to the node A is shown in FIG. 4.

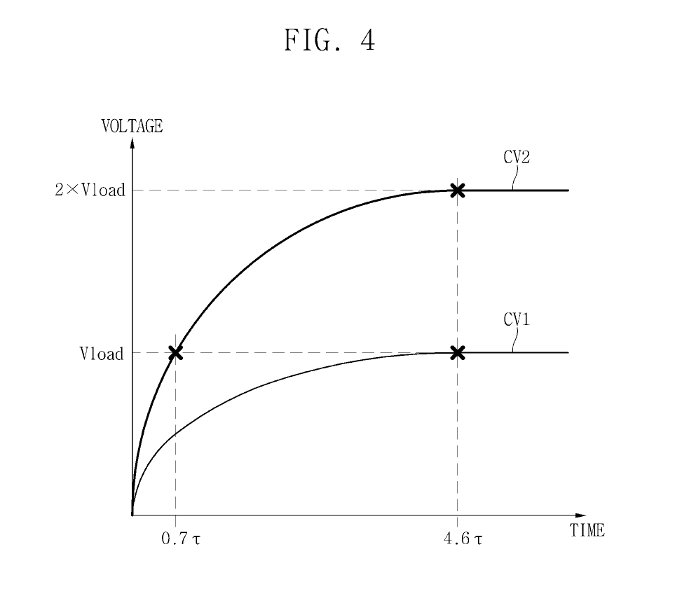

FIGS. 3A and 3B illustrate an input signal of the channel driver shown in FIG. 2, respectively.

Referring to FIGS. 2 and 3A, an input signal IN is shown. During a normal operation, the channel driver 170 receives an input voltage Vin as the input signal IN.

Referring to FIGS. 2 and 3B, during the normal operation, the channel driver 170 receives the input voltage Vin as the input signal IN. During an overdriving operation OP, the display driving device 100 receives an overdriving input voltage 2×Vin as the input signal IN so as to shorten a time reaching a level of a predetermined target voltage.

FIG. 4 is a graph showing a variation of voltage according to a time in the display panel shown in FIG. 2.

Referring to FIGS. 2 to 4, a horizontal axis represents a time, and a vertical axis represents a voltage level of the node A.

A first curve CV1 represents change of the voltage of the node A when the input voltage Vin is applied to the display panel 200. A second curve CV2 represents the change of the voltage of the node A when the overdriving input voltage 2×Vin which is two times greater than the input voltage Vin is applied to the display panel 200.

Equation 1 is a formula for calculating a time constant. [Equation 1]

τ=R×C

R represents a resistance value, and C represents a capacitance value. That is, a value τ (tau) obtained by multiplying R and C represents a time constant.

A time required to reach the level Vload of a predetermined target voltage for operating the display panel 200 is 4.6τ when the input voltage Vin is applied as shown in the first curve CV1, and is 0.7τ when the overdriving input voltage 2×Vin which is two times greater than the input voltage Vin is applied as shown in the second curve CV2.

The time required to reach the level Vload of the predetermined target voltage is determined by the time constant. Accordingly, the higher a level of the input voltage Vin is (that is, an overdriving operation is performed), the shorter the time required to reach the level of the predetermined target voltage (that is, a target voltage level) is.

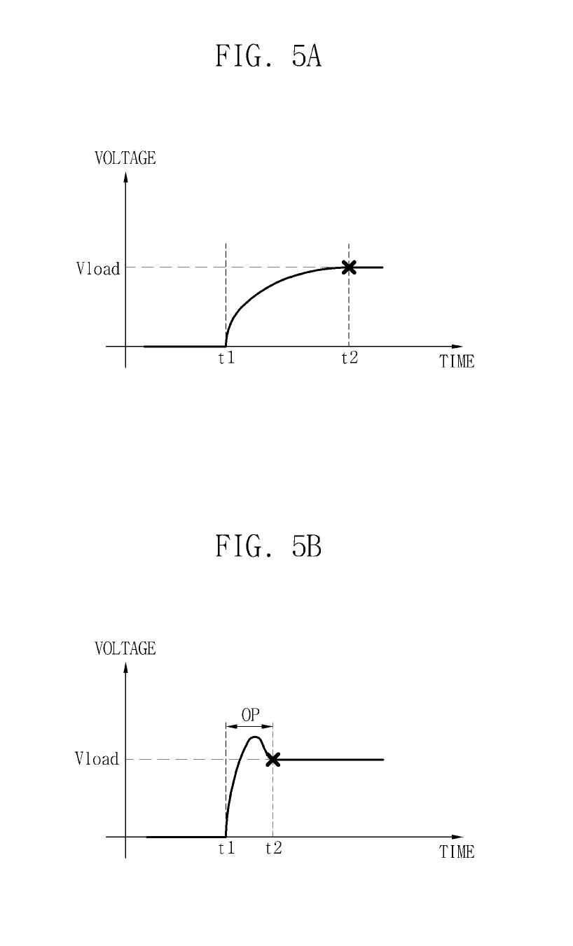

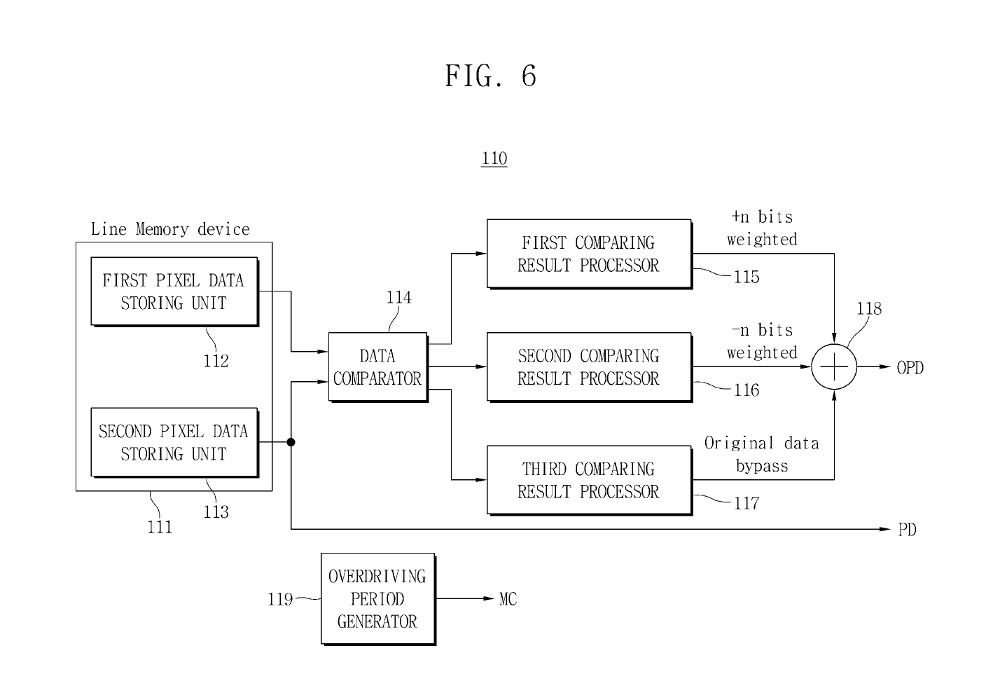

FIGS. 5A and 5B are graphs showing a load voltage according to a time at a node A shown in FIG. 2, respectively.

Referring to FIGS. 2 and 5A, a curve shown in FIG. 5A shows a change of a voltage at the node A when the input voltage Vin shown in FIG. 3A is applied to the display panel 200.

Referring to FIGS. 2 and 5B, a curve shown in FIG. 5B shows a change of a voltage at the node A when the overdriving input voltage 2×Vin shown in FIG. 3B is applied to the display panel 200.

The display driving device 100 may increase a level of the input voltage Vin by two times during the overdriving operation OP. The channel driver 170 receives an overdriving input voltage (that is, 2×Vin) which is two times greater than the input voltage Vin while the display driving device 100 performs an overdriving operation. That is, when the overdriving operation is performed, the voltage at the node A reaches the target voltage level Vload more quickly.

FIG. 6 is a block diagram illustrating a timing controller shown in FIG. 1.

Referring to FIGS. 1 and 6, the timing controller 110 according to an exemplary embodiment of the present inventive concept compares previous pixel data and current pixel data by units of a line to perform an overdriving operation. Particularly, the timing controller 110 includes a line memory device 111, a data comparator 114, first to third comparing result processors 115 to 117, and a calculating unit 118.

The line memory device 111 includes a first pixel data storing unit 112 to store the previous pixel data PD_{N}, and a second pixel data storing unit 113 to store the current pixel data PD_{N+1}.

The data comparator 114 compares the previous pixel data PD_{N} and the current pixel data PD_{N+1} by units of a line. The data comparator 114 selects one of the first to third comparing result processors 115 to 117 based on the compared result.

Specifically, when the current pixel data PD_{N+1} is greater than the previous pixel data PD_{N}, the data comparator 114 selects the first comparing result processor 115. The first comparing result processor 115 adds n-bit weight data to the current pixel data PD_{N+1} through the calculating unit 118. In an exemplary embodiment, when the pixel data PD is 8-bit data, the n-bit weight data may be one of 3-bit, 4-bit, and 5-bit data.

It is assumed that the current pixel data PD_{N+1} has 8-bit color depth and the n-bit weight data is 4-bit data. That is, the calculating unit 118 adds 8′b00001111 which is a binary number (that is, 15 which is a decimal number) to the current pixel data PD_{N+1}.

For example, when the previous pixel data PD_{N} is 8′b10000000 which is a binary number (128 which is a decimal number) and the current pixel data PD_{N+1} is 8′b10010000 which is a binary number (136 which is a decimal number), the current pixel data PD_{N+1} is greater than the previous pixel data PD_{N}. In this case, the data comparator 114 selects the first comparing result processor 115. The first comparing result processor 115 adds 8′b00001111 which is a binary number (that is, 15 which is a decimal number) to the current pixel data PD_{N+1} through the calculating unit 118. Accordingly, the current pixel data PD_{N+1} is 8′b10011111 which is a binary number (that is, 151 which is a decimal number).

Further, when the previous pixel data PD_{N} is 8′b10010000 which is a binary number (136 which is a decimal number) and the current pixel data PD_{N+1} is 8′b10000000 which is a binary number (128 which is a decimal number), the current pixel data PD_{N+1} is smaller than the previous pixel data PD_{N}. In this case, the data comparator 114 selects the second comparing result processor 116. The second comparing result processor 116 subtracts 8′b00001111 which is a binary number (that is, 15 which is a decimal number) from the current pixel data PD_{N+1} through the calculating unit 118. Accordingly, the current pixel data PD_{N+1} is 8′b01110001 which is a binary number (that is, 113 which is a decimal number).

Moreover, when the previous pixel data PD_{N} is 8′b10010000 which is a binary number (136 which is a decimal number) and the current pixel data PD_{N+1} is 8′b10010000 which is a binary number (136 which is a decimal number), the current pixel data PD_{N+1} is equal to the previous pixel data PD_{N}. In this case, the data comparator 114 selects the third comparing result processor 117. The third comparing result processor 117 transmits the current pixel data PD_{N+1} to the shift register 120 by bypassing the calculating unit 118.

As another embodiment, it is assumed that the current pixel data PD_{N+1} has 8-bit color depth and n-bit weight data is 5-bit data. That is, the calculating unit 118 adds 8′b00011111 which is a binary number (that is, 31 which is a decimal number) to the current pixel data PD_{N+1}.

For example, when the previous pixel data PD_{N} is 8′b10000000 which is a binary number (128 which is a decimal number) and the current pixel data PD_{N+1} is 8′b10010000 which is a binary number (136 which is a decimal number), the current pixel data PD_{N+1} is greater than the previous pixel data PD_{N}. In this case, the data comparator 114 selects the first comparing result processor 115. The first comparing result processor 115 adds 8′b00011111 which is a binary number (that is, 31 which is a decimal number) to the current pixel data PD_{N+1} through the calculating unit 118. Accordingly, the current pixel data PD_{N+1} is 8′b10101111 which is a binary number (that is, 187 which is a decimal number).

Further, when the previous pixel data PD_{N} is 8′b10010000 which is a binary number (136 which is a decimal number) and the current pixel data PD_{N+1} is 8′b10000000 which is a binary number (128 which is a decimal number), the current pixel data PD_{N+1} is smaller than the previous pixel data PD_{N}. In this case, the data comparator 114 selects the second comparing result processor 116. The second comparing result processor 116 subtracts 8′b00011111 which is a binary number (that is, 31 which is a decimal number) from the current pixel data PD_{N+1} through the calculating unit 118. Accordingly, the current pixel data PD_{N+1} is 8′b01100001 which is a binary number (that is, 97 which is a decimal number).

Moreover, when the previous pixel data PD_{N} is 8′b10010000 which is a binary number (136 which is a decimal number) and the current pixel data PD_{N+1} is 8′b10010000 which is a binary number (136 which is a decimal number), the current pixel data PD_{N+1} is equal to the previous pixel data PD_{N}. In this case, the data comparator 114 selects the third comparing result processor 117. The third comparing result processor 117 transmits the current pixel data PD_{N+1} to the shift register 120 by bypassing the calculating unit 118.

The timing controller 110 further includes an overdriving period generator 119. The overdriving period generator 119 generates a MUX control signal MC. For example, while the MUX control signal MC is activated, the display driving device 100 performs an overdriving operation. On the contrary, while the MUX control signal MC is deactivated, the display driving device 100 performs a normal operation.

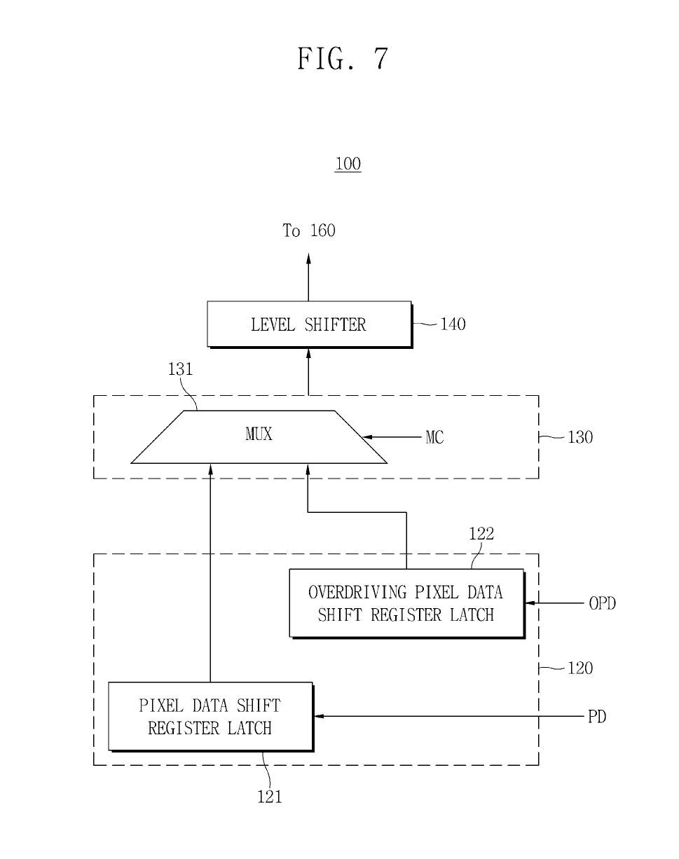

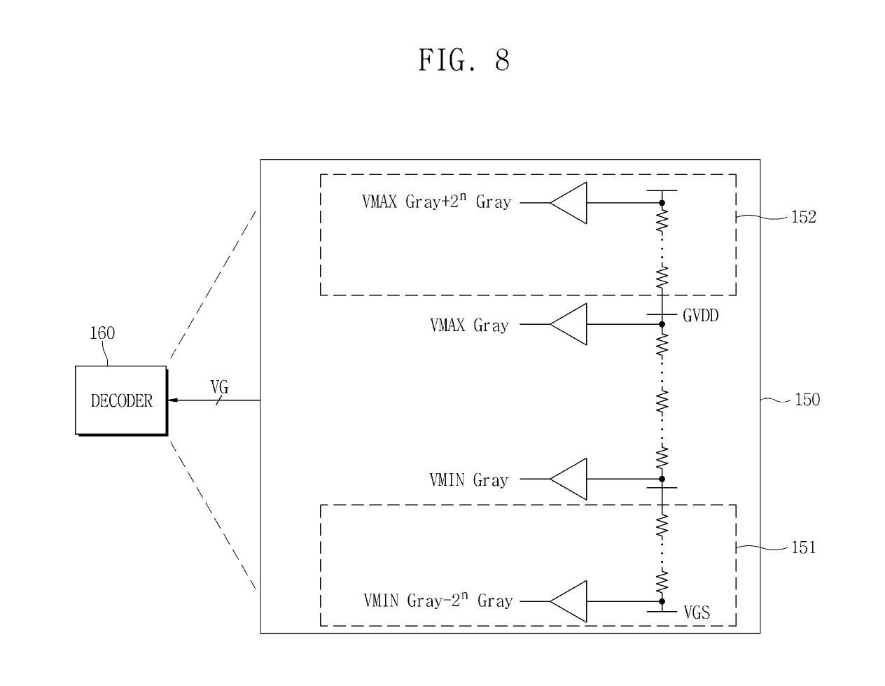

FIG. 7 is a block diagram illustrating a shift register, a MUX controller, and a level shifter shown in FIG. 1.

Referring to FIGS. 1 and 7, the shift register 120 includes a pixel data shift register latch 121 to shift pixel data, and an overdriving pixel data shift register latch 122 to shift overdriving pixel data.

The pixel data shift register latch 121 stores the pixel data PD input from the timing controller 110. The overdriving pixel data shift register latch 122 stores the overdriving pixel data OPD input from the timing controller 110.

The MUX controller 130 transmits one of the pixel data PD and the overdriving pixel data OPD to the level shifter 140 in response to the MUX control signal MC transmitted from the timing controller 110.

FIG. 8 is a circuit diagram illustrating a decoder and a gray scale generator shown in FIG. 1.

Referring to FIGS. 1 and 8, the gray scale generator 150 generates a gray scale voltage VG. The decoder 160 receives the gray scale voltage VG from the gray scale generator 150. In an exemplary embodiment, the gray scale generator 150 may be implemented by a register string in which a plurality of resistors are connected in series.

For example, when the pixel data is 8-bit data, the decoder 160 may generate 2⁸ (256) decoded data. The gray scale generator 150 includes a register string in which 2⁸ (256) resistors are connected in series to generate a gray scale voltage corresponding to 8-bit pixel data. That is, the gray scale generator 150 transmits the gray scale voltage VG represented as 2⁸ (256) voltages to the decoder 160.

Further, the gray scale generator 150 according to an embodiment of the present inventive concept further includes first and second extension gray scale generators 151 and 152 for extending the gray scale voltage corresponding to the n-bit weight data.

That is, when subtracting the n-bit weight data from the pixel data PD of 8-bit, the first extension gray scale generator 151 generates 2ⁿ gray scale voltages VMIN Gray−2ⁿ Gray smaller than a gray scale voltage VMIN Gray of when the pixel data PD has the smallest value (that is, 8′b00000000). When adding the n-bit weight data to the pixel data PD of 8-bit, the second extension gray scale generator 152 generates 2ⁿ gray scale voltages VMAX Gray+2ⁿ Gray greater than a gray scale voltage VMAX Gray of when the pixel data has the greatest value (that is, 8′b11111111).

For example, when the n-bit weight data is 4-bit data, the gray scale generator 150 generates 2⁸+2×2⁴ gray scale voltages. Further, when the n-bit weight data is 5-bit data, the gray scale generator 150 generates 2⁸+2×2⁵ gray scale voltages.

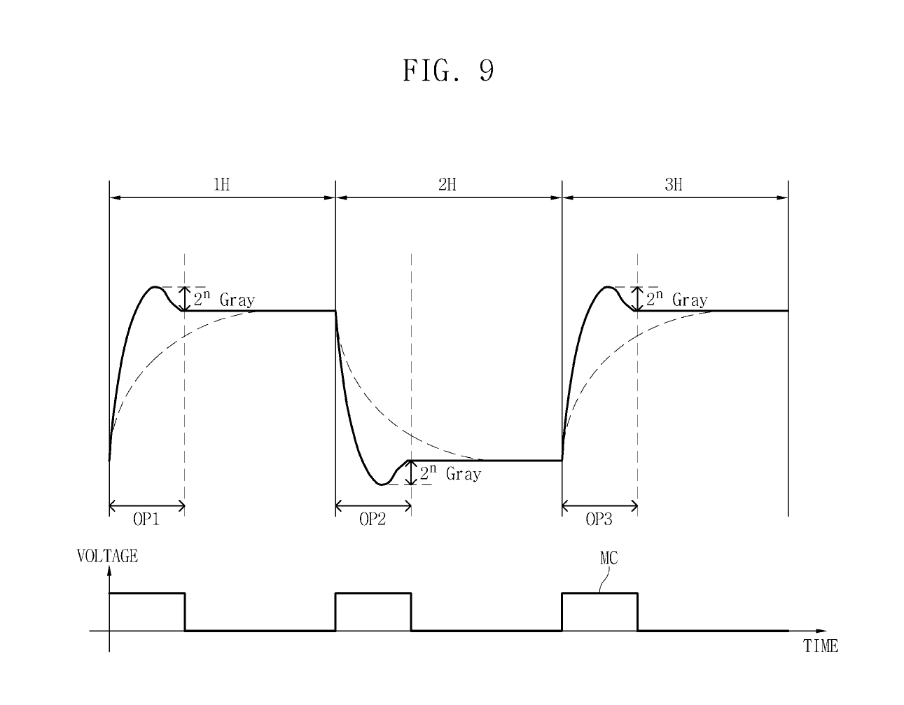

FIG. 9 is a timing diagram describing an operation of a display driving circuit shown in FIG. 1.

Referring to FIGS. 1 and 9, while the MUX control signal MC is activated, an overdriving operation is performed.

In a first horizontal period 1H, during a first overdriving operation OP1, the timing controller 110 activates the MUX control signal MC. The MUX controller 130 transmits the overdriving pixel data OPD to the decoder 160 through the level shifter 140. The decoder 160 transmits the gray scale voltage VG corresponding to the overdriving pixel data OPD to the channel driver 170.

During the first overdriving operation OP1, when adding the n-bit weight data to the pixel data PD, the overdriving pixel data OPD is greater than the pixel data PD by 2ⁿ.

In the first horizontal period 1H, when the timing controller 110 deactivates the MUX control signal MC, the MUX controller 130 transmits the pixel data PD to the decoder 160 through the level shifter 140. The decoder 160 transmits the gray scale voltage VG corresponding to the pixel data PD to the channel driver 170.

In a second horizontal period 2H, during a second overdriving operation OP2, the timing controller 110 activates the MUX control signal MC. The MUX controller 130 transmits the overdriving pixel data OPD to the decoder 160 through the level shifter 140. The decoder 160 transmits the gray scale voltage VG corresponding to the overdriving pixel data OPD to the channel driver 170.

During the second overdriving operation OP2, when subtracting the n-bit weight data from the pixel data PD, the overdriving pixel data OPD is smaller than the pixel data PD by 2ⁿ.

In the second horizontal period 2H, when the timing controller 110 deactivates the MUX control signal MC, the MUX controller 130 transmits the pixel data PD to the decoder 160 through the level shifter 140. The decoder 160 transmits the gray scale voltage VG corresponding to the pixel data PD to the channel driver 170.

In a third horizontal period 3H, during a third overdriving operation OP3, the timing controller 110 activates the MUX control signal MC. The MUX controller 130 transmits the overdriving pixel data OPD to the decoder 160 through the level shifter 140. The decoder 160 transmits the gray scale voltage VG corresponding to the overdriving pixel data OPD to the channel driver 170.

During the third overdriving operation OP3, when adding the n-bit weight data to the pixel data PD, the overdriving pixel data OPD is greater than the pixel data PD by 2ⁿ.

In the third horizontal period 3H, when the timing controller 110 deactivates the MUX control signal MC, the MUX controller 130 transmits the pixel data PD to the decoder 160 through the level shifter 140. The decoder 160 transmits the gray scale voltage VG corresponding to the pixel data PD to the channel driver 170.

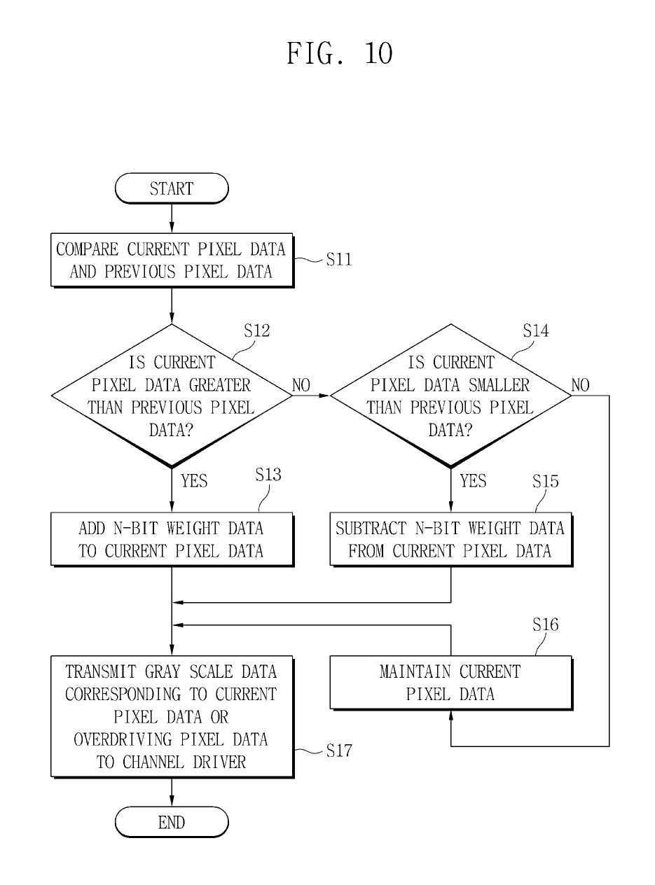

FIG. 10 is a flowchart describing an operation method of a display driving circuit shown in FIG. 1.

Referring to FIGS. 1, 6, and 10, in operation S11, the timing controller 110 compares the previous pixel data PD_{N} and the current pixel data PD_{N+1} by units of a line.

In operation S12, the timing controller 110 determines whether the current pixel data PD_{N+1} is greater than the previous pixel data PD_{N} based on the compared result. If so, the timing controller 110 performs operation S13, but if not, the timing controller 110 performs operation S14.

In the operation S13, the timing controller 110 generates the overdriving pixel data OPD by adding n-bit weight data to the current pixel data PD_{N+1}.

In operation S14, the timing controller 110 determines whether the current pixel data PD_{N+1} is smaller than the previous pixel data PD_{N} based on the compared result. If so, the timing controller 110 performs operation S15, but if not, the timing controller 110 performs operation S16.

In the operation S15, the timing controller 110 generates the overdriving pixel data OPD by subtracting the n-bit weight data from the current pixel data PD_{N+1}.

In the operation S16, the timing controller 110 determines whether the current pixel data PD_{N+1} is equal to the previous pixel data PD_{N} based on the compared result. If so, the timing controller 110 transmits the pixel data PD to the shift register 120.

In operation S17, the gray scale generator 150 generates the gray scale voltage corresponding to the pixel data PD. Further, the gray scale generator 150 generates the gray scale voltage corresponding to the overdriving pixel data OPD including an extension bit. The decoder 160 transmits the gray scale voltage corresponding to the pixel data PD or the gray scale voltage corresponding to the overdriving pixel data OPD to the channel driver 170.

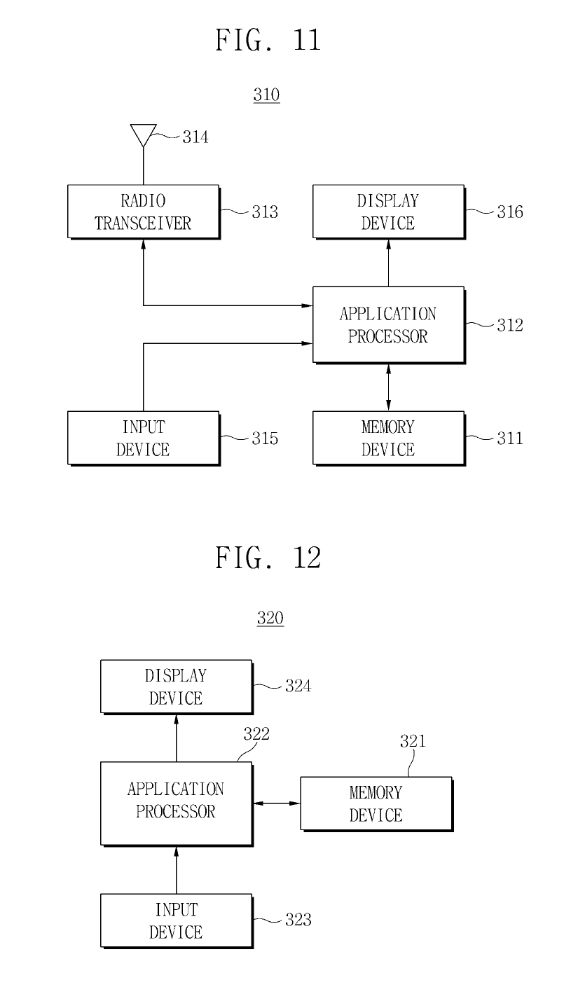

FIG. 11 is a block diagram illustrating an exemplary embodiment of a computer system including the display device shown in FIG. 1.

Referring to FIG. 11, a computer system 310 includes a memory device 311, an application processor 312 including a memory controller to control the memory device 311, a radio transceiver 313, an antenna 314, an input device 315, and a display device 316.

The radio transceiver 313 transmits and receives a radio signal through the antenna 314. For example, the radio transceiver 313 converts the radio signal received through the antenna 314 into a signal which can be processed in the application processor 312.

Accordingly, the application processor 312 processes a signal output from the radio transceiver 313, and transmits the processed signal to the display device 316. Further, the radio transceiver 313 converts the signal output from the application processor 312 into the radio signal, and transmits the converted radio signal to an external device through the antenna 314.

The input device 315 is a device to input a control signal to control an operation of the application processor 312 or data to be processed by the application processor 312, and may be implemented as a pointing device such as a touchpad and a computer mouse, a keypad, or a keyboard.

In one embodiment, the display device 316 may be implemented to have the display device 10 shown in FIG. 1.

FIG. 12 is a block diagram illustrating another embodiment of a computer system including the display device shown in FIG. 1.

Referring to FIG. 12, a computer system 320 may be a personal computer (PC), a network server, a tablet PC, a netbook, an e-reader, a personal digital assistant (PDA), a portable multimedia player (PMP), an MP3 player, or an MP4 player.

The computer system 320 includes a memory device 321, an application processor 322 including a memory controller for controlling a data processing operation of the memory device 321, an input device 323, and a display device 324.

The application processor 322 displays data stored in the memory device 321 through the display device 324 according to data input through the input device 323. For example, the input device 323 may be implemented as a pointing device such as a touchpad or a computer mouse, a keypad, or a keyboard. The application processor 322 controls overall operations of the computer system 320 and operations of the memory device 321.

According to an embodiment, the display device 324 may be implemented to have the display device 10 shown in FIG. 1.

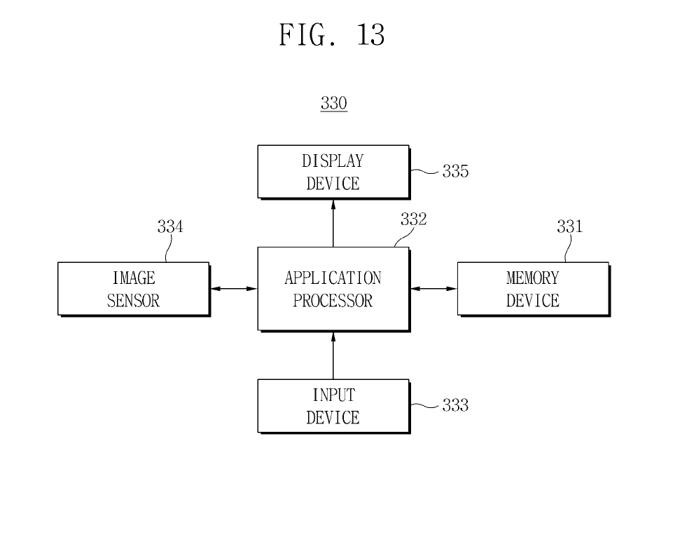

FIG. 13 is a block diagram illustrating still another embodiment of a computer system including the display device shown in FIG. 1.

Referring to FIG. 13, a computer system 330 may be an image processing device, for example, a digital camera, or a mobile phone, a smartphone or a tablet PC on which the digital camera is installed.

The computer system 330 includes a memory device 331, an application processor 332 including a memory controller for controlling a data processing operation, for example, a write operation or a read operation, of the memory device 331, an input device 333, an image sensor 334, and a display device 335.

The image sensor 334 of the computer system 330 converts an optical image into digital signals, and the converted digital signals are transmitted to the application processor 332. According to control of the application processor 332, the converted digital signals are displayed through the display device 335, or stored in the memory device 331.

Further, the data stored in the memory device 331 is displayed through the display device 335 according to the control of the application processor 332.

The input device 333 is a device for inputting a control signal for controlling an operation of the application processor 332 or data to be processed by the application processor 332, and may be implemented as a pointing device such as a touchpad and a computer mouse, a keypad, or a keyboard.

In one embodiment, the display device 335 may be implemented to have the display device 10 shown in FIG. 1.

The display driving device according to embodiments of the inventive concept compares previous pixel data and current pixel data in units of line, and performs an overdriving operation based on the compared result. Accordingly, the display driving device can improve a slew rate at a load terminal of the display panel.

The foregoing is illustrative of embodiments and is not to be construed as limiting thereof. Although a few embodiments have been described, those skilled in the art will readily appreciate that many modifications are possible without materially departing from the novel teachings and advantages. Accordingly, all such modifications are intended to be included within the scope of this inventive concept as defined in the claims. In the claims, means-plus-function clauses are intended to cover the structures described herein as performing the recited function, and not only structural equivalents but also equivalent structures.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display driving device, comprising:
a timing controller configured to compare previous pixel data and current pixel data in units of a line, add or subtract n-bit weight data to or from the current pixel data based on the compared result, and generate the added or subtracted current pixel data as overdriving pixel data; and
a channel driver configured to transmit a gray scale voltage corresponding to the overdriving pixel data to a display panel, during an overdriving operation.

2. The display driving device according to claim 1, wherein the timing controller adds the n-bit weight data to the current pixel data, when the current pixel data is greater than the previous pixel data.

3. The display driving device according to claim 1, wherein the timing controller subtracts the n-bit weight data from the current pixel data, when the current pixel data is smaller than the previous pixel data.

4. The display driving device according to claim 1, wherein the timing controller maintains the current pixel data, when the current pixel data is equal to the previous pixel data.

5. The display driving device according to claim 1, further comprising:
a shift register configured to store each of the current pixel data and the overdriving pixel data;
a MUX controller configured to output one of the current pixel data and the overdriving pixel data; and
a level shifter configured to shift a voltage level of the current pixel data or the overdriving pixel data received from the MUX controller.

6. The display driving device according to claim 5, further comprising:
a decoder configured to decode the current pixel data or the overdriving pixel data received from the level shifter.

7. The display driving device according to claim 6, further comprising:
a gray scale generator configured to transmit the gray scale voltage to the decoder.

8. The display driving device according to claim 5, wherein the timing controller generates a MUX control signal to control the overdriving operation, and
the MUX controller outputs one of the current pixel data and the overdriving pixel data in response to the MUX control signal.

9. The display driving device according to claim 1, wherein the current pixel data comprises 8-bit, and
the n is greater than or equal to 3 and is smaller than or equal to 5.

10. The display driving device according to 1, wherein the channel driver transmits the gray scale voltage corresponding to the current pixel data to the display panel, during a normal operation.

11. A display driving method, comprising:
comparing current pixel data and previous pixel data in units of line;
adding or subtracting n-bit weight data to or from the current pixel data based on the compared result;
generating the added or subtracted current pixel data as overdriving pixel data; and
transmitting a gray scale voltage corresponding to the overdriving pixel data to a display panel, during an overdriving operation.

12. The display driving method according to claim 11, wherein the adding or subtracting of the n-bit weight data to or from the current pixel data based on the compared result, comprises:
adding the n-bit weight data to the current pixel data, when the current pixel data is greater than the previous pixel data; and
subtracting the n-bit weight data from the current pixel data, when the current pixel data is smaller than the previous pixel data.

13. The display driving method according to claim 11, wherein the adding or subtracting of the n-bit weight data to or from the current pixel data based on the compared result, comprises maintaining the current pixel data, when the current pixel data is equal to the previous pixel data.

14. The display driving method according to claim 11, further comprising:
storing each of the current pixel data and the overdriving pixel data; and
outputting one of the current pixel data and the overdriving pixel data in response to a MUX control signal for selecting the overdriving operation.

15. The display driving method according to claim 14, further comprising shifting a voltage level of the current pixel data or the overdriving pixel data.

16. A display driving device, comprising:
a timing controller configured to compare previous pixel data and current pixel data in units of a line and to generate overdriving pixel data based on the comparison; and
a channel driver configured to transmit a gray scale voltage corresponding to the overdriving pixel data to a display panel, during an overdriving operation, otherwise to transmit a gray scale voltage corresponding to the current pixel data to a display panel during a normal operation.

17. The display driving device of according to claim 16, wherein the timing controller generates the overdriving pixel data by adding or subtracting n-bit weight data to or from the current pixel data based on the compared result to provide the overdriving pixel data.

18. The display driving device of according to claim 17, wherein the timing controller adds the n-bit weight data to the current pixel data, when the current pixel data is greater than the previous pixel data, subtracts the n-bit weight data from the current pixel data, when the current pixel data is smaller than the previous pixel data, and maintains the current pixel data, when the current pixel data is equal to the previous pixel data.

19. The display driving device according to claim 16, further comprising:
a shift register configured to store each of the current pixel data and the overdriving pixel data;
a MUX controller configured to output one of the current pixel data and the overdriving pixel data; and
a level shifter configured to shift a voltage level of the current pixel data or the overdriving pixel data received from the MUX controller.

20. The display driving device according to claim 19, further comprising:
a decoder configured to decode the current pixel data or the overdriving pixel data received from the level shifter.
